(19) United States
(12) Patent Application Publication
(10) Pub. No.: US 2015/0228399 A1
(43) Pub. Date: Aug. 13, 2015

(54) COIL DEVICE

(71) Applicant: SHT Corporation Limited, Izumisano-shi, Osaka (JP)

(72) Inventors: Hitoshi Yoshimori, Izumisano-shi (JP); Tsunetsugu Imanishi, Izumisano-shi (JP)

(21) Appl. No.: 14/426,255

(22) PCT Filed: Aug. 22, 2013
(86) PCT No.: PCT/JP2013/072346

§ 371 Date: Mar. 5, 2015

(30) Foreign Application Priority Data
Sep. 11, 2012 (JP) 2012-199389

(51) Int. Cl. H01F 27/28

(52) U.S. Cl. CPC H01F 27/2895

(57) ABSTRACT

Provided is a coil device in which an insulation breakdown between unit winding portions can be suppressed effectively and which can be easily formed by hand winding. The coil device according to the present invention includes a ring-shaped core and at least one coil formed by continuously winding one conductor wire around the core. The coil is formed by a plurality of unit coil portions successively formed along a direction of a magnetic path of the core, the adjacent unit coil portions are electrically connected to each other at only one position, each of the unit coil portions is formed by a plurality of unit winding portions stacked at least on an inner peripheral side of the core, and a layered structure of each of the unit coil portions at least on the inner peripheral side of the core is formed by stacking the one unit winding portion on the two unit winding portions in a lower layer.

### TECHNICAL FIELD

The present invention relates to a coil device formed by winding a conductor wire around a ring-shaped core.

### BACKGROUND ART

Conventionally, there is a known coil device formed by winding conductor wires around a ring-shaped core (toroidal core) (Patent Document 1).

For example, a coil device shown in FIG. 25 includes three coils 6, 6, and 6 formed by winding conductor wires 60 around a ring-shaped core 1 without a gap portion and three-phase AC voltage is applied to the three coils 6, 6, and 6.

The core 1 is formed by covering a surface of a ring-shaped magnetic core piece with an insulating resin case.

FIG. 26 shows an order of winding of the one coil 6 in the coil device with a numerical winding number and the coil 6 has a one-layer structure on an outer peripheral side of the core 1 and a two-layer structure on an inner peripheral side.

As shown in the diagram, first, a plurality of unit winding portions forming a unit coil portion of the first layer on the inner peripheral side of the core 1 are wound in the order of winding of 0→0.5→1→1.5→2→ . . . →8→8.5 and then a plurality of unit winding portions forming a unit coil portion of the second layer are wound in the order of winding of 9→9.5→10→10.5→11→ . . . →14→14.5.

Conventionally, such winding of the conductor wires 60 in the coil device is carried out manually.

### PRIOR ART DOCUMENTS

### Patent Documents

Patent Document 1: Japanese Patent Laid-open Publication No. 2012-15426
Patent Document 2: Japanese Patent Laid-open Publication No. 2003-86438

### SUMMARY OF THE INVENTION

### Problems to be Solved by the Invention

However, in the coil device shown in FIG. 26, the unit winding portion number 0.5 and the unit winding portion number 14.5 overlap each other on the inner peripheral side of the core. As a result, a large potential difference proportional to a difference, 14, between the numbers of the order of winding of the two unit winding portions occurs between the two unit winding portions to cause an insulation breakdown between the two unit winding portions.

Therefore, there are proposed a coil device (hereafter referred to as a “bank wound coil device”) formed by winding a coil around a core having a magnetic gap portion and a method of manufacturing the same. In the coil device, a coil is formed by a plurality of unit coil portions formed by spirally winding one conductor wire, these unit coil portions are arranged repeatedly in a direction of a winding axis, each of the unit coil portions is formed by a plurality of unit winding portions having different inner periphery lengths from each other, and at least parts of the unit winding portions having the shorter inner periphery lengths are into the unit winding portions having longer inner periphery lengths (Patent Document 2).

According to the bank wound coil device, the unit winding portions are stacked up from a lower layer to an upper layer in a winding step of each of the unit coil portions. As a result, a potential difference between the two unit winding portions in contact with each other reduces and it is possible to effectively suppress an insulation breakdown between the unit winding portions.

However, the method of manufacturing the bank wound coil device is intended for the core having the magnetic gap portion and it is impossible to efficiently manufacture a bank wound coil device having a core without a magnetic gap portion by using an automated machine.

Moreover, it is extremely difficult to form the bank wound coil device by hand winding.

It is an object of the present invention to provide a coil device having a core without a magnetic gap portion, in which an insulation breakdown between unit winding portions can be suppressed effectively and which can be easily formed by hand winding.

### Means for Solving the Problems

A coil device according to the present invention includes a ring-shaped core and at least one coil formed by continuously winding one conductor wire around the core. The coil is formed by a plurality of unit coil portions successively formed along a direction of a magnetic path of the core, the adjacent unit coil portions are electrically connected to each other at only one position, each of the unit coil portions is formed by a plurality of unit winding portions stacked at least on an inner peripheral side of the core by continuously winding the conductor wire, and a layered structure of each of the unit coil portions at least on the inner peripheral side of the core is formed by stacking the one unit winding portion in an upper layer on the two unit winding portions in a lower layer in arbitrary three unit winding portions positioned at three vertices of a triangle.

In other words, the layered structure of each of the unit coil portions at least on the inner peripheral side of the core is formed by repeatedly forming a layer unit pattern including the three unit winding portions formed by stacking the one unit winding portion in the upper layer on the two unit winding portions in the lower layer.

Here, when the layer unit pattern is formed repeatedly, each of the three unit winding portions forming each of the layer unit patterns is positioned so as not to overlap the unit winding portions of another layer unit pattern or one of the three unit winding portions forming each of the layer unit patterns is positioned so as to overlap one of the unit winding portions of another layer unit pattern.

In a winding process of the coil device according to the present invention, the plurality of unit coil portions are successively formed along the direction of the magnetic path of the core by continuously winding the one conductor wire around the core.

In a winding process of each of the unit coil portions, unit winding processing in which the three unit winding portions positioned at the three vertices of the triangle are wound is repeated in a step of layering the respective unit winding portions at least on the inner peripheral side of the core.

In this way, the one unit winding portion is stacked on the two unit winding portions in the lower layer. By repeatedly forming the layer unit pattern formed by the three unit winding portions, the one unit coil portion is formed.

In this manner, the plurality of unit coil portions are successively formed along the direction of the magnetic path of the core and therefore a potential difference between the adjacent unit coil portions becomes small. Moreover, in the winding process of each of the unit coil portions, unit winding processing of forming the three unit winding portions is repeated and therefore a potential difference between the unit winding portions in the one unit coil portion becomes small as well.

### Effects of the Invention

According to the present invention, in the coil device formed by winding the coil around the core having the magnetic gap portion, the insulation breakdown between the unit winding portions in contact with each other can be suppressed effectively and the coil device can be easily formed by hand winding.

### BRIEF DESCRIPTION OF THE DRAWINGS

FIG. 1 is a partially cutaway plan view of a first embodiment in which the present invention is embodied in a two-layer coil device.

FIG. 2 is a partially cutaway plan view of a second embodiment in which the present invention is embodied in a two-layer coil device.

FIG. 3 is a diagram showing an order of winding in the coil device in the first embodiment.

FIG. 4 is a diagram showing an order of winding in the coil device in the second embodiment.

FIG. 5 is a perspective view showing how to illustrate a start and an end of winding in a process of winding a conductor wire around a core.

FIG. 6 is a diagram showing a first step of a winding process in the coil device in the first embodiment.

FIG. 7 is a diagram showing a second step of the same.

FIG. 8 is a diagram showing a third step of the same.

FIG. 9 is a diagram showing a fourth step of the same.

FIG. 10 is a diagram showing a fifth step of the same.

FIG. 11 is a diagram showing a sixth step of the same.

FIG. 12 is a diagram showing a first step of a winding process in the coil device in the second embodiment.

FIG. 13 is a diagram showing a second step of the same.

FIG. 14 is a diagram showing a third step of the same.

FIG. 15 is a diagram showing a fourth step of the same.

FIG. 16 is a diagram showing a fifth step of the same.

FIG. 17 is a diagram showing a sixth step of the same.

FIG. 18 is a partially cutaway plan view of a third embodiment in which the present invention is embodied in a three-layer coil device.

FIG. 19 is a partially cutaway plan view of a fourth embodiment in which the present invention is embodied in a three-layer coil device.

FIG. 20 is a diagram showing an order of winding in the coil device in the third embodiment.

FIG. 21 is a diagram showing an order of winding in the coil device in the fourth embodiment.

FIG. 22 is a diagram showing an order of winding in a coil device in a fifth embodiment in which the present invention is embodied in a two-layer coil device.

FIGS. 23(a) to 23(c) are diagrams showing first, second, and third steps of a winding process in the coil device in the fifth embodiment.

FIGS. 24(a) to 24(c) are diagrams showing fourth, fifth, and sixth steps of the same.

FIG. 25 is a partially cutaway plan view of a conventional coil device.

FIG. 26 is a diagram showing an order of winding in the conventional coil device.

### DETAILED DESCRIPTION OF EMBODIMENTS

Embodiments of the present invention will be specifically described below with reference to the drawings. In the drawings, numbers in circles illustrating sections of a conductor wire show an order of winding of the conductor wire and an increment when the conductor wire is wound to make a circuit (360°) is illustrated as “1” and an increment when the conductor wire is wound to make half a circuit (180°) is illustrated as “0.5”.

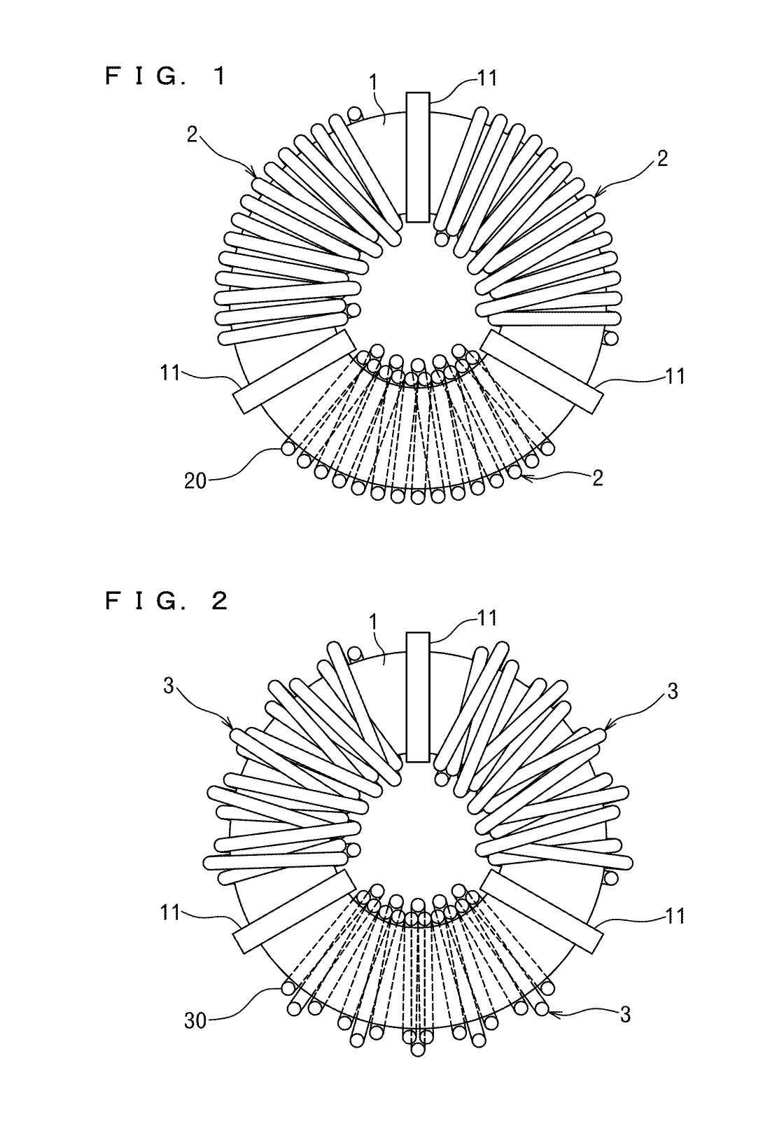

In the coil device as the first embodiment of the present invention, as shown in FIG. 1, three ribs 11, 11, and 11 are formed to protrude at intervals of 120° from a ring-shaped core 1 without a magnetic gap portion. A coil 2 is formed by winding a conductor wire 20, having a surface to which an insulating coating is applied, between the adjacent two ribs 11 and 11. Three-phase AC voltage is applied to the three coils 2, 2, and 2.

The core 1 is formed by covering a surface of a ring-shaped magnetic core piece with an insulating resin case.

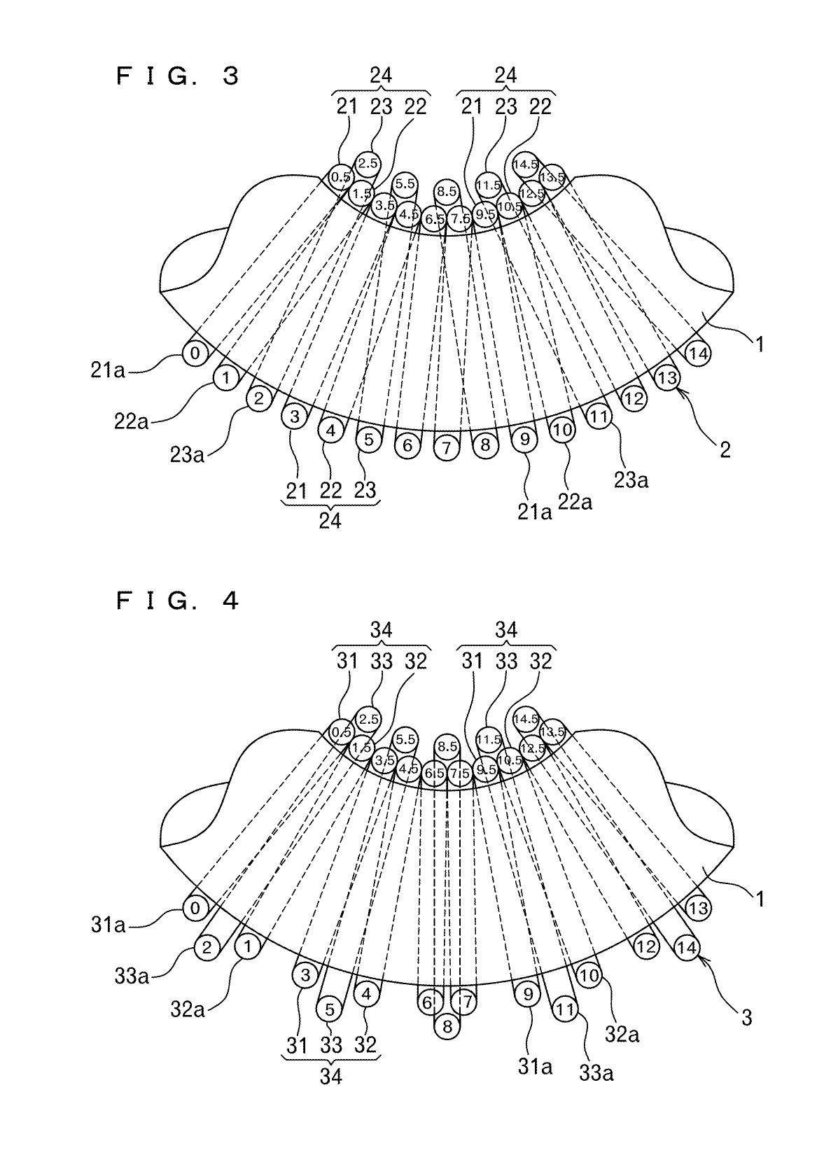

In the coil device, each of the coils 2 is formed by continuously winding the one conductor wire 20 and has a one-layer structure on an outer peripheral side of the core 1 and a two-layer structure on an inner peripheral side of the core 1, as shown in FIG. 3.

The coil 2 is formed by successively winding a plurality of unit coil portions 24 in a counterclockwise direction along a magnetic path of the core 1 and the adjacent unit coil portions 24 and 24 are connected to each other by the one conductor wire at only one position.

Each of the unit coil portions 24 is formed by a first unit winding portion 21, a second unit winding portion 22, and a third unit winding portion 23 and these unit winding portions 21a, 22a, and 23a are arranged in order along the core 1 on the outer peripheral side of the core 1.

On the other hand, on the inner peripheral side of the core 1, the first unit winding portion 21, the second unit winding portion 22, and the third unit winding portion 23 are positioned at three vertices of a triangle and the third unit winding portion 23 in an upper layer is stacked on the first unit winding portion 21 and the second unit winding portion 22 in the lower layer.

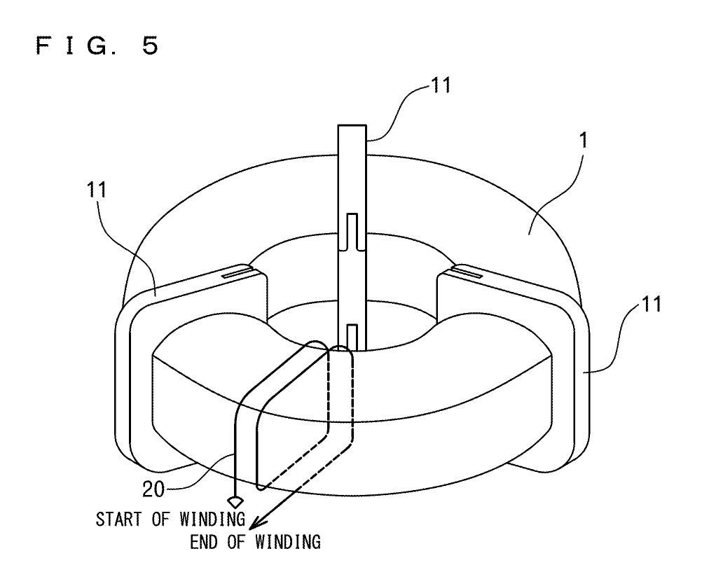

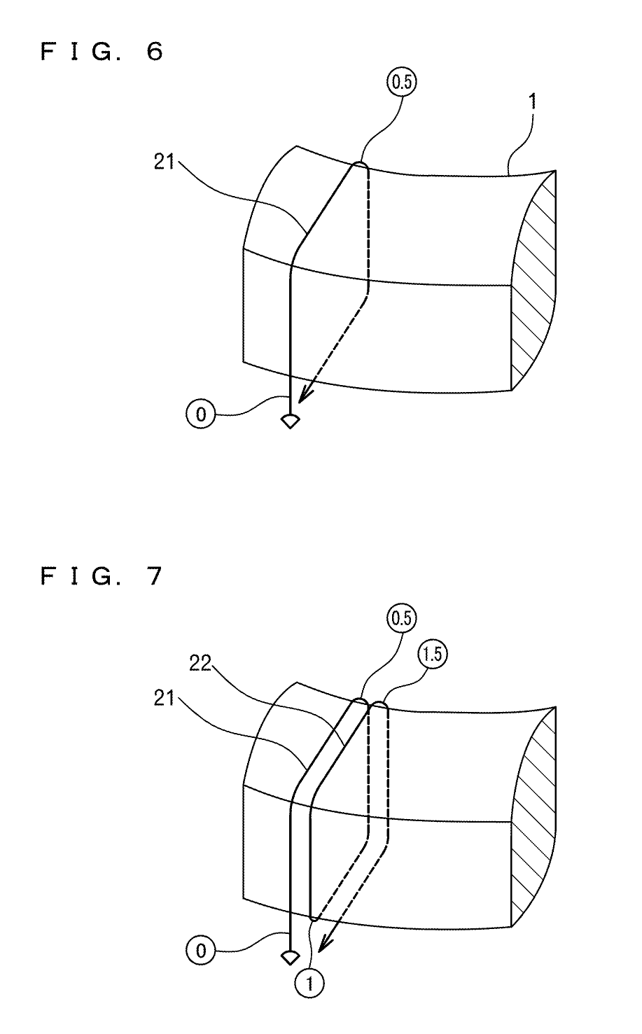

FIGS. 6 to 11 show a winding process of the coil 2 in the coil device. In these process diagrams, a start of winding and an end of winding are illustrated as in FIG. 5.

First, after the first unit winding portion 21 is formed as shown in FIG. 6, the second unit winding portion 22 is formed beside the first unit winding portion 21 as shown in FIG. 7. Then, the third unit winding portion 23 is formed so as to be stacked on the first unit winding portion 21 and the second unit winding portion 22 on the inner peripheral side of the core as shown in FIG. 8, which completes the one unit coil portion 24.

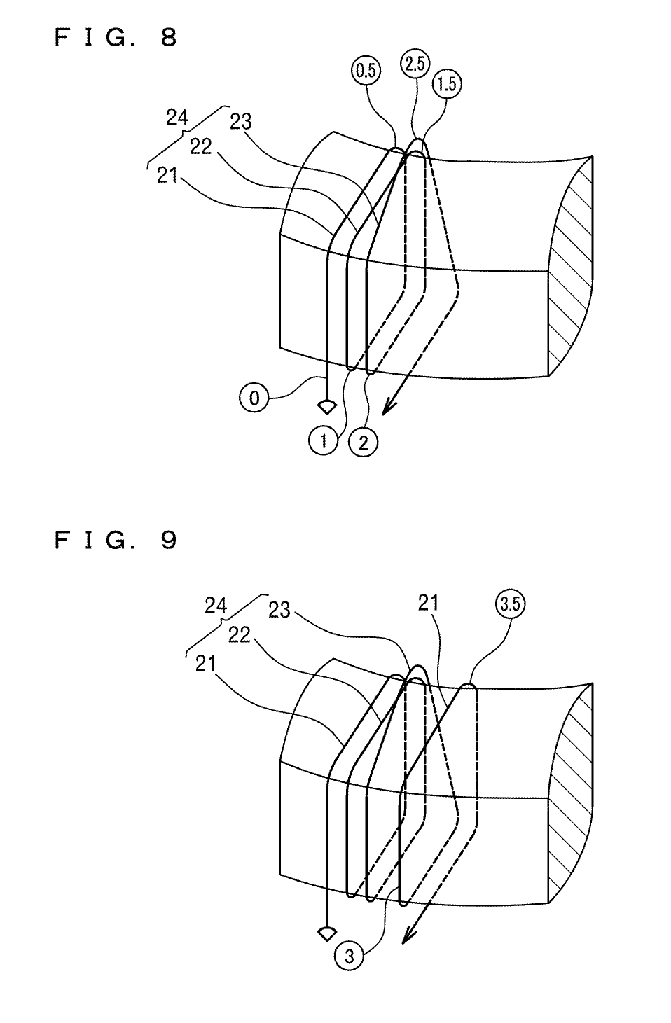

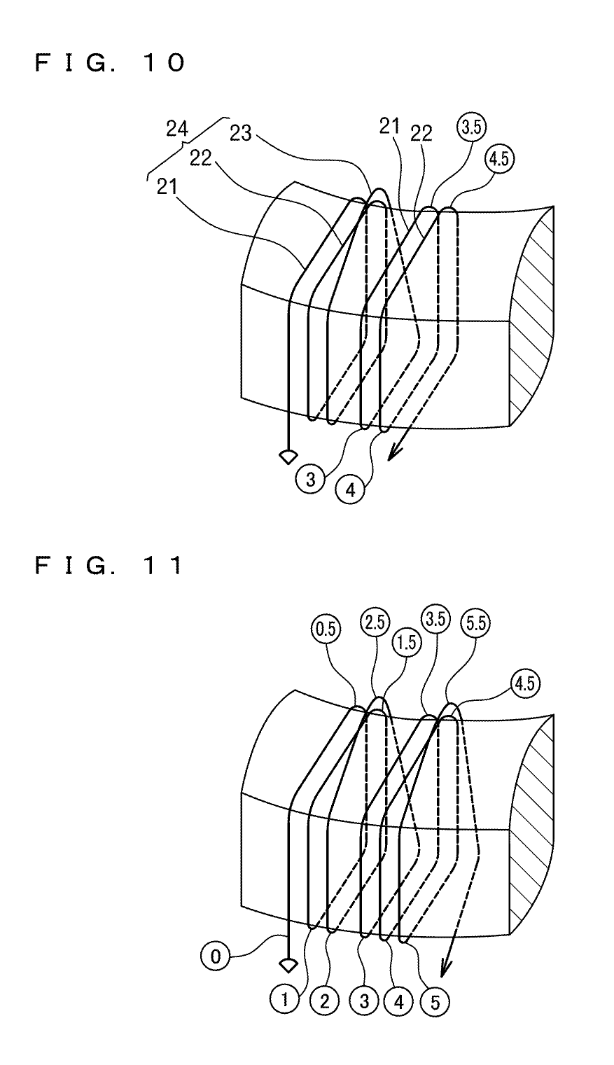

Next, as shown in FIG. 9, the next first unit winding portion 21 is formed beside the unit coil portion 24. After that, the same process is repeated to thereby successively form the plurality of unit coil portions 24 as shown in FIGS. 10 and 11.

In a coil device as the second embodiment of the present invention, as shown in FIG. 2, three coils 3, 3, and 3 are formed by winding conductor wires 20 each having a surface to which an insulating coating is applied, around a ring-shaped core 1 without a magnetic gap portion.

In the coil device, each of the coils 3 is formed by continuously winding the one conductor wire 30 and has a two-layer structure on an inner peripheral side of the core 1 and a two-layer structure in which portions of the conductor wires do not overlap each other on an outer peripheral side of the core 1 as shown in FIG. 4.

The coil 3 is formed by successively winding a plurality of unit coil portions 34 in a counterclockwise direction along a magnetic path of the core 1 and the adjacent unit coil portions 34 and 34 are connected to each other by the one conductor wire at only one position.

Each of the unit coil portions 34 is formed by a first unit winding portion 31, a second unit winding portion 32, and a third unit winding portion 33. On the outer peripheral side of the core 1, the first unit winding portion 31a, the third unit winding portion 33a, and the second unit winding portion 32a are arranged in this order in the counterclockwise direction along the core 1.

On the other hand, on the inner peripheral side of the core 1, the first unit winding portion 31, the second unit winding portion 32, and the third unit winding portion 33 are positioned at three vertices of a triangle and the third unit winding portion 33 in an upper layer is stacked on the first unit winding portion 31 and the second unit winding portion 32 in the lower layer.

FIGS. 12 to 17 show a winding process of the coil 3 in the coil device.

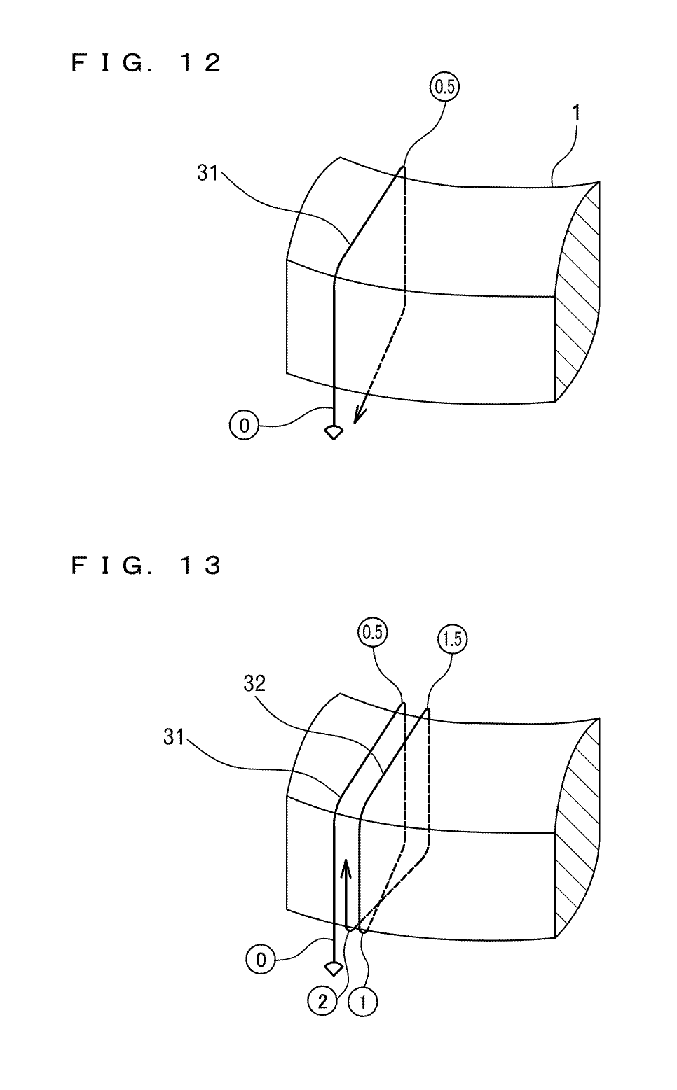

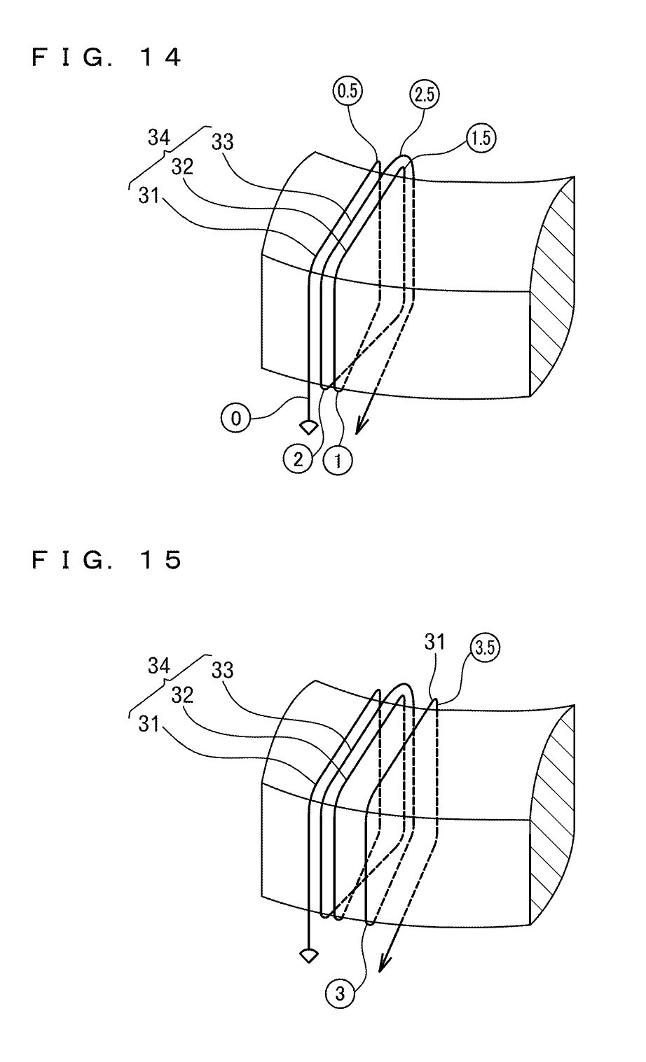

First, after the first unit winding portion 31 is formed as shown in FIG. 12, the second unit winding portion 22 is formed beside the first unit winding portion 31 as shown in FIG. 13. Then, as shown in FIG. 14, the third unit winding portion 33 is formed so as to be disposed between the first unit winding portion 31 and the second unit winding portion 32 on the outer peripheral side of the core and to be stacked on the first unit winding portion 31 and the second unit winding portion 32 on the inner peripheral side of the core, which completes the one unit coil portion 34.

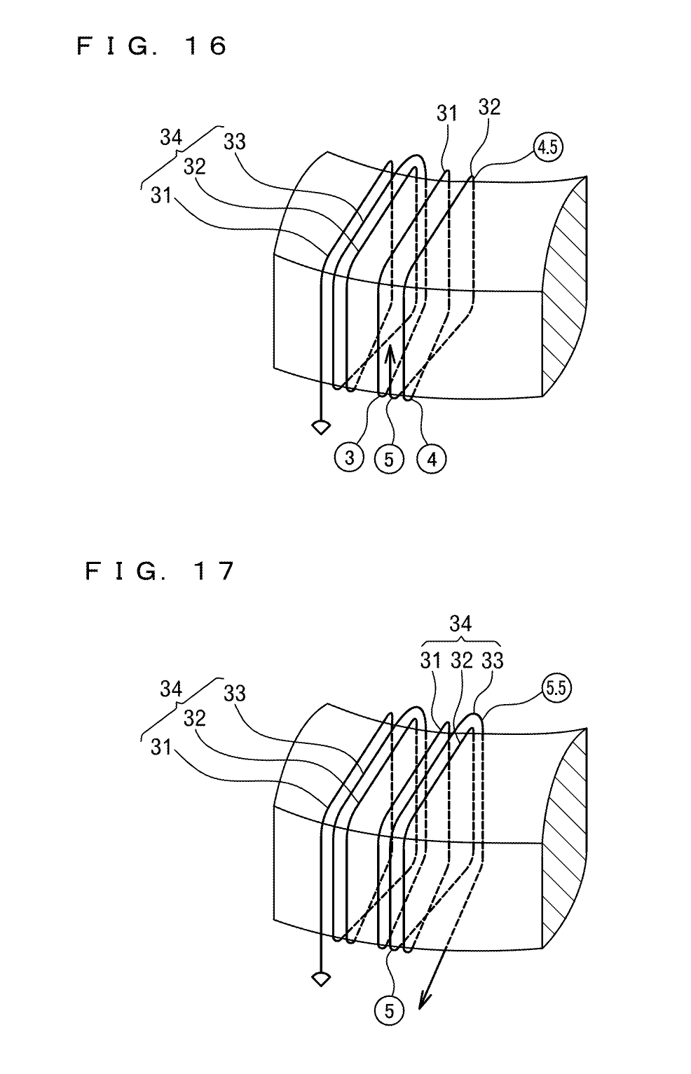

Next, as shown in FIG. 15, the next first unit winding portion 31 is formed beside the unit coil portion 34. After that, the same process is repeated to thereby successively form the plurality of unit coil portions 34 as shown in FIGS. 16 and 17.

In a coil device as the third embodiment of the present invention, as shown in FIG. 18, three coils 4, 4, and 4 are formed by winding conductor wires 40 each having a surface to which an insulating coating is applied, around a ring-shaped core 1 without a magnetic gap portion.

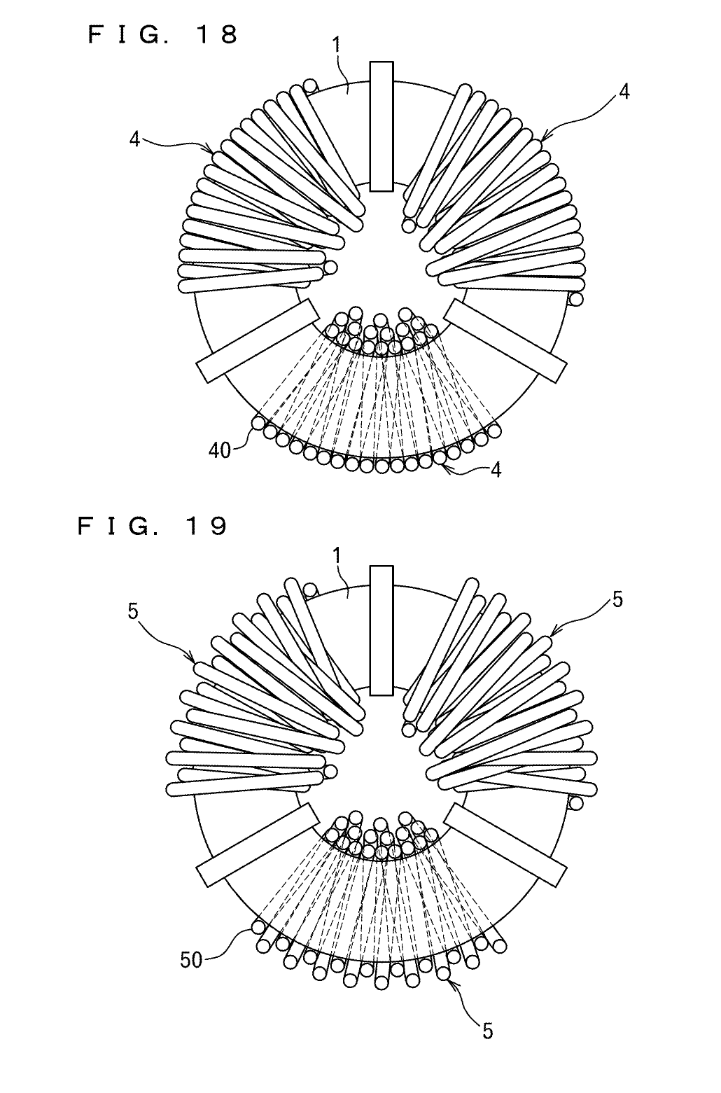

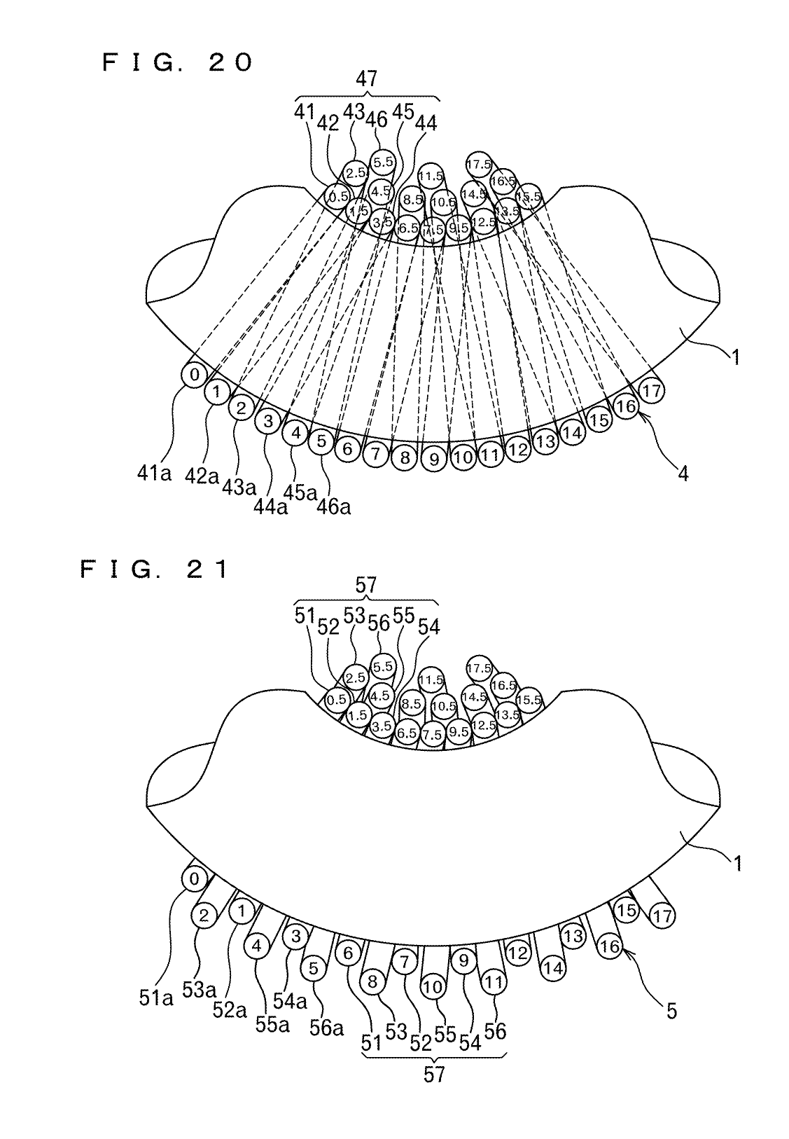

In the coil device, each of the coils 4 is formed by continuously winding the one conductor wire 40 and has a one-layer structure on an outer peripheral side of the core 1 and a three-layer structure on an inner peripheral side of the core 1 as shown in FIG. 20.

The coil 4 is formed by successively winding a plurality of unit coil portions 47 in a counterclockwise direction along a magnetic path of the core 1 and the adjacent unit coil portions 47 and 47 are connected to each other by the one conductor wire at only one position.

Each of the unit coil portions 47 is formed by a first unit winding portion 41, a second unit winding portion 42, a third unit winding portion 43, a fourth unit winding portion 44, a fifth unit winding portion 45, and a sixth unit winding portion 46. On the outer peripheral side of the core 1, these unit winding portions 41a, 42a, 43a, 44a, 45a, and 46a are arranged in this order along the core 1.

On the other hand, on the inner peripheral side of the core 1, the first unit winding portion 41, the second unit winding portion 42, and the third unit winding portion 43 are positioned at three vertices of a triangle and the third unit winding portion 43 is stacked on the first unit winding portion 41 and the second unit winding portion 42. Furthermore, the second unit winding portion 42, the fourth unit winding portion 44, and the fifth unit winding portion 45 are positioned at three vertices of a triangle and the fifth unit winding portion 45 is stacked on the second unit winding portion 42 and the fourth unit winding portion 44. Moreover, the third unit winding portion 43, the fifth unit winding portion 45, and the sixth unit winding portion 46 are positioned at three vertices of a triangle and the sixth unit winding portion 46 is stacked on the third unit winding portion 43 and the fifth unit winding portion 45.

The coil 4 can be easily formed by the similar winding process to that of the coil device in the above-described first embodiment.

In a coil device as the fourth embodiment of the present invention, as shown in FIG. 19, three coils 5, 5, and 5 are formed by winding conductor wires 50 each having a surface to which an insulating coating is applied, around a ring-shaped core 1 without a magnetic gap portion.

In the coil device, each of the coils 5 is formed by continuously winding the one conductor wire 50 and has a three-layer structure on an inner peripheral side of the core 1 and a two-layer structure in which portions of the conductor wires do not overlap each other on an outer peripheral side of the core 1 as shown in FIG. 21.

The coil 5 is formed by successively winding a plurality of unit coil portions 57 in a counterclockwise direction along a magnetic path of the core 1 and the adjacent unit coil portions 57 and 57 are connected to each other by the one conductor wire at only one position.

Each of the unit coil portions 57 is formed by a first unit winding portion 51, a second unit winding portion 52, a third unit winding portion 53, a fourth unit winding portion 54, a fifth unit winding portion 55, and a sixth unit winding portion 56. On the outer peripheral side of the core 1, the first unit winding portion 51a, the third unit winding portion 53a, the second unit winding portion 52a, the fifth unit winding portion 55a, the fourth unit winding portion 54a, and the sixth unit winding portion 56a are arranged in this order in the counterclockwise direction along the core 1.

On the other hand, on the inner peripheral side of the core 1, the first unit winding portion 51, the second unit winding portion 52, and the third unit winding portion 53 are positioned at three vertices of a triangle and the third unit winding portion 53 is stacked on the first unit winding portion 51 and the second unit winding portion 52. Furthermore, the second unit winding portion 52, the fourth unit winding portion 54, and the fifth unit winding portion 55 are positioned at three vertices of a triangle and the fifth unit winding portion 55 is stacked on the second unit winding portion 52 and the fourth unit winding portion 54. Moreover, the third unit winding portion 53, the fifth unit winding portion 55, and the sixth unit winding portion 56 are positioned at three vertices of a triangle and the sixth unit winding portion 56 is stacked on the third unit winding portion 53 and the fifth unit winding portion 55.

The coil 5 can be easily formed by the similar winding process to that of the coil device in the above-described second embodiment.

In each of the coil devices in the above-described first to fourth embodiments, the plurality of unit coil portions are successively formed along the direction of the magnetic path of the core and therefore a potential difference between the adjacent unit coil portions becomes small. Moreover, the unit winding portions are stacked from the lower layer to the upper layer in the winding process of each of the unit coil portions similarly to the method of manufacturing the bank wound coil device. Therefore, a difference between the numbers of winding of the two unit winding portions in the lower layer and the winding number of the one unit winding portion in the upper layer is as small as “2” in the two-layer structures shown in FIGS. 3 and 4 and is as small as “3” in the three-layer structures shown in FIGS. 20 and 21, which substantially reduces the potential difference between the unit winding portions as compared with the conventional coil device shown in FIG. 26 in which the maximum difference is “14”.

As a result, it is possible to effectively suppress an insulation breakdown between the unit winding portions similarly to the bank wound coil device.

Each of the coil devices in the first to fourth embodiments employs the method in which the respective unit coil portions are formed by repeating the winding operation of stacking the one unit winding portion on the already-wound two unit winding portions. Therefore, it is easy to manually carry out the winding without using the method of manufacturing the bank wound coil device.

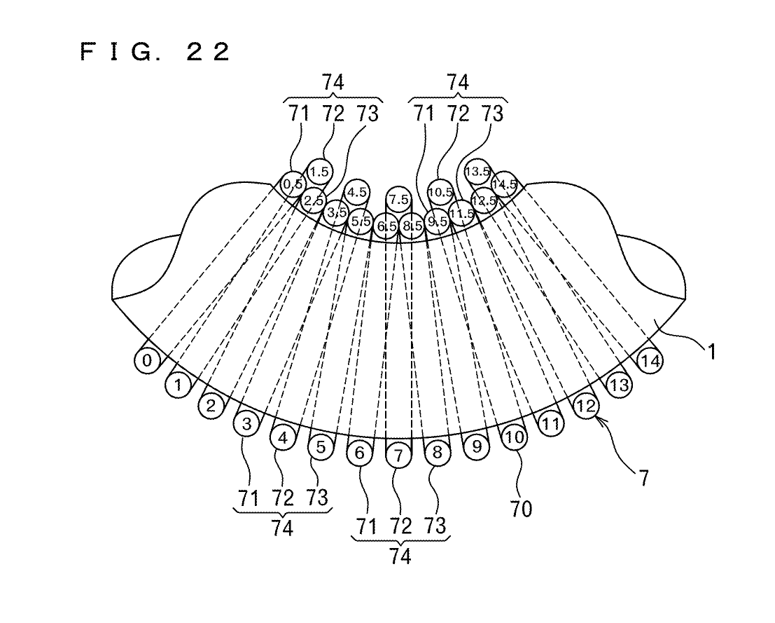

FIG. 22 shows a coil device as the fifth embodiment of the present invention.

As shown in the diagram, a coil 7 is formed by continuously winding a conductor wire 70, having a surface to which an insulating coating is applied, around a ring-shaped core 1. The coil 7 has a one-layer structure on an outer peripheral side of the core 1 and a two-layer structure on an inner peripheral side of the core 1.

The coil 7 is formed by successively winding a plurality of unit coil portions 74 in a counterclockwise direction along a magnetic path of the core 1 and the adjacent unit coil portions 74 and 74 are connected to each other by the one conductor wire at only one position.

Each of the unit coil portions 74 is formed by a first unit winding portion 71, a second unit winding portion 72, and a third unit winding portion 73. On the outer peripheral side of the core 1, these unit winding portions 71, 72, and 73 are arranged in this order along the core 1.

On the other hand, on the inner peripheral side of the core 1, the first unit winding portion 71, the second unit winding portion 72, and the third unit winding portion 73 are positioned at three vertices of a triangle and the second unit winding portion 72 in an upper layer is stacked on the first unit winding portion 71 and the third unit winding portion 73 in the lower layer.

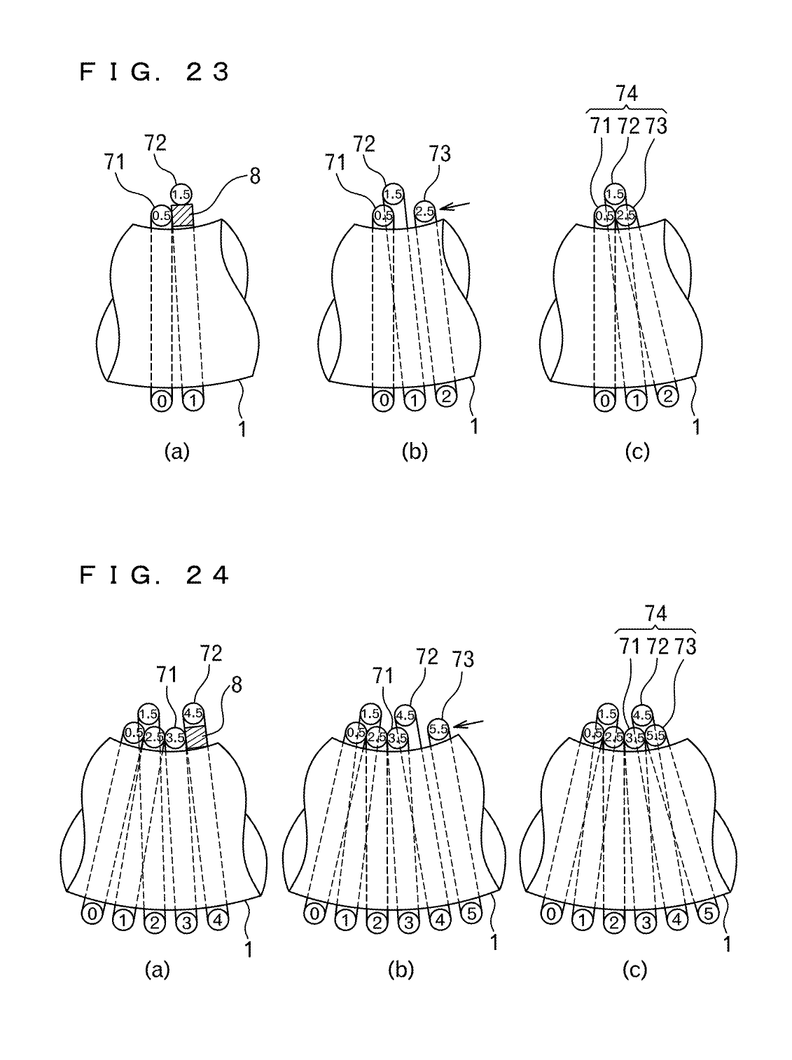

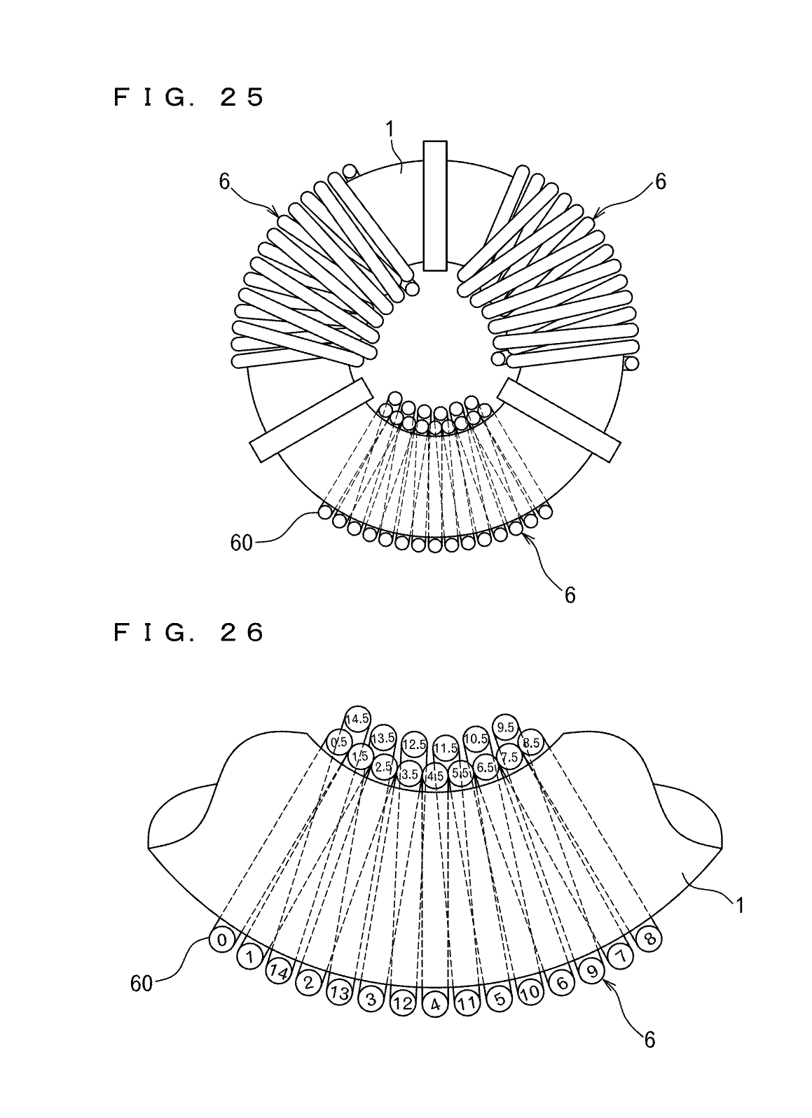

FIGS. 23(a) to 24(c) show a winding process of the coil 7 in the coil device.

First, after the first unit winding portion 71 is formed as shown in FIG. 23(a), a spacer 8 is disposed beside the first unit winding portion 71 on the inner peripheral side of the core and the second unit winding portion 72 is formed so as to surround the core 1 and the spacer 8.

After that, as shown in FIG. 23(b), the spacer 8 is removed and the third winding portion 73 is wound beside the second unit winding portion 72. Then, the third winding portion 73 is pushed toward the first unit winding portion 71 as shown with an arrow on the inner peripheral side of the core and the third unit winding portion 73 is pushed under the second unit winding portion 72. In this way, as shown in FIG. 24c, the one unit coil portion 74 in which the second unit winding portion 72 in the upper layer is stacked on the first unit winding portion 71 and the third winding portion 73 in the lower layer is formed.

Next, after the first unit winding portion 71 is formed as shown in FIG. 24(a), the spacer 8 is disposed beside the first unit winding portion 71 on the inner peripheral side of the core and the second unit winding portion 72 is formed so as to surround the core 1 and the spacer 8.

After that, as shown in FIG. 24 (b), the spacer 8 is removed and the third winding portion 73 is wound beside the second unit winding portion 72. Then, the third winding portion 73 is pushed toward the first unit winding portion 71 as shown with an arrow on the inner peripheral side of the core and the third unit winding portion 73 is pushed under the second unit winding portion 72. In this way, as shown in FIG. 24c, the one unit coil portion 74 in which the second unit winding portion 72 in the upper layer is stacked on the first unit winding portion 71 and the third winding portion 73 in the lower layer is formed.

By successively forming the plurality of unit coil portions 74 in this manner, the coil 7 shown in FIG. 22 is completed.

In arrangements of the three unit winding portions 71, 72, and 73 forming each of the unit coil portions 74 in the coil 7, the second unit winding portion 72 is stacked on the third unit winding portion 73 unlike in arrangements of the three unit winding portions 21, 22, and 23 in the first embodiment shown in FIG. 3. With the winding process shown in FIGS. 23(a) to 24(c), for example, it is easy to form the unit coil portion 74 having such a layered structure.

In the coil device shown in FIG. 22, the plurality of unit coil portions 74 are successively formed along the direction of the magnetic path of the core 1 and therefore a potential difference between the adjacent unit coil portions 74 and 74 becomes small. Moreover, a difference between the winding numbers of the first unit winding portion 71 and the third unit winding portion 73 in contact with each other is as small as “2”, which makes the potential difference between the unit winding portions much smaller than that in the conventional coil device, because the maximum difference is “14” in the conventional coil device shown in FIG. 26.

As a result, it is possible to effectively suppress an insulation breakdown between the unit winding portions similarly to the bank wound coil device.

In a coil device having a three-layer structure on an inner peripheral side of a core 1, by repeating unit winding processing of winding three unit winding portions 71, 72, and 73 positioned at three vertices of a triangle on the inner peripheral side of the core 1, it is possible to obtain the coil device with a small potential difference between the unit winding portions in contact with each other.

Structures of the respective portions of the present invention are not limited to those in the above-described embodiments and can be modified in various ways within a technical scope described in claims. For example, the conductor wire is not limited to a round wire having a circular section but may be various conductor wires having oval and rectangular sections.

The conductor wire is not limited to a solid conductor wire but may be a hollow conductor wire having a through hole in the wire.

### DESCRIPTION OF REFERENCE CHARACTERS

1 core
2 coil
21 first unit winding portion
22 second unit winding portion
23 third unit winding portion
24 unit coil portion
3 coil
31 first unit winding portion
32 second unit winding portion
33 third unit winding portion
34 unit coil portion
4 coil
41 first unit winding portion
42 second unit winding portion
43 third unit winding portion
44 fourth unit winding portion
45 fifth unit winding portion
46 sixth unit winding portion
47 unit coil portion
5 coil
51 first unit winding portion
52 second unit winding portion
53 third unit winding portion
54 fourth unit winding portion
55 fifth unit winding portion
56 sixth unit winding portion
57 unit coil portion
7 coil
71 first unit winding portion
72 second unit winding portion
73 third unit winding portion
74 unit coil portion

1. A coil device comprising a ring-shaped core and at least one coil formed by continuously winding one conductor wire around the core,
wherein the coil is formed by a plurality of unit coil portions successively formed along a direction of a magnetic path of the core, the adjacent unit coil portions are electrically connected to each other at only one position,
each of the unit coil portions is formed by a plurality of unit winding portions stacked at least on an inner peripheral side of the core by winding the conductor wire, and
a layered structure of each of the unit coil portions at least on the inner peripheral side of the core is formed by stacking the one unit winding portion in an upper layer on the two unit winding portions in a lower layer in three unit winding portions positioned at three vertices of a triangle.

2. The coil device according to claim 1, wherein the three unit winding portions are wound continuously and successively.

3. The coil device according to claim 1, wherein, when a winding order of the plurality of unit winding portions forming the coil is expressed as consecutive winding numbers, the layered structure of each of the unit coil portions at least on the inner peripheral side of the core is formed by stacking the one unit winding portion having a greater winding number than the two unit winding portions in the lower layer on both the unit winding portions in arbitrary three unit winding portions positioned at three vertices of the triangle.

4. A coil device comprising a ring-shaped core and at least one coil formed by continuously winding one conductor wire around the core,
wherein the coil is formed by a plurality of unit coil portions successively formed along a direction of a magnetic path of the core, the adjacent unit coil portions are electrically connected to each other at only one position,
each of the unit coil portions is formed by a plurality of unit winding portions stacked at least on an inner peripheral side of the core by winding the conductor wire, and
a layered structure of each of the unit coil portions at least on the inner peripheral side of the core is formed by repeatedly forming a layer unit pattern including the three unit winding portions formed by stacking the one unit winding portion in an upper layer on the two unit winding portions in a lower layer.

5. The coil device according to claim 4, wherein, when the layer unit pattern is formed repeatedly, each of the three unit winding portions forming each of the layer unit patterns is positioned so as not to overlap the unit winding portions of another layer unit pattern.

6. The coil device according to claim 4, wherein, when the layer unit pattern is formed repeatedly, one of the three unit winding portions forming each of the layer unit patterns is positioned so as to overlap one of the unit winding portions of another layer unit pattern.

7. The coil device according to claim 4, wherein, when a winding order of the plurality of unit winding portions forming the coil is expressed as consecutive winding numbers, a layered structure of each of the unit coil portions at least on the inner peripheral side of the core is formed by repeatedly forming a layer unit pattern including the three unit winding portions formed by stacking the one unit winding portion having a greater winding number than the two unit winding portions in the lower layer on both the unit winding portions.

8. The coil device according to claim 1, wherein, in the layered structure of each of the unit coil portions at least on the inner peripheral side of the core, the number of unit winding portions forming each coil layer reduces from a lower coil layer toward an upper coil layer.

9. The coil device according to claim 1, wherein three coils to which three-phase AC voltage is to be applied are wound around the core.

10. The coil device according to claim 4, wherein, in the layered structure of each of the unit coil portions at least on the inner peripheral side of the core, the number of unit winding portions forming each coil layer reduces from a lower coil layer toward an upper coil layer.

11. The coil device according to claim 4, wherein three coils to which three-phase AC voltage is to be applied are wound around the core.
